(19) United States
(12) Patent Application Publication
(10) Pub. No.: US 2005/0039010 A1
(43) Pub. Date: Feb. 17, 2005

(54) Method and apparatus for authenticating to a remote server

(76) Inventor: Brian D. Grove, Laguna Niguel, CA (US)

Correspondence Address: GATES & COOPER LLP;HOWARD HUGHES CENTER, 6701 CENTER DRIVE WEST, SUITE 1050, LOS ANGELES, CA, 90045, US

(21) Appl. No.: 10/872,354

(22) Filed: Jun. 18, 2004

Related U.S. Application Data
(60) Provisional application No. 60/483,845, filed on Jun. 30, 2003.

(51) Int. Cl. H04L 9/00

(52) U.S. Cl. 713/170

(57) ABSTRACT

A method and apparatus for authenticating a user is disclosed. The method uses a portable I/O device to display a challenge from a kiosk or other multi-user computer and to enter a response to the challenge and transmit that response to the multi-user computer. The portable I/O device interfaces with a hardware security device, which generates the response using data securely stored in therein.

### CROSS-REFERENCE TO RELATED APPLICATIONS

This application claims benefit of U.S. Provisional Patent Application No. 60/483,845, entitled “METHOD AND APPARATUS FOR AUTHENTICATING TO A REMOTE SERVER,” by Brian D. Grove, filed Jun. 30, 2003, which application is hereby incorporated by reference herein.

### BACKGROUND OF THE INVENTION

1. Field of the Invention

The present invention relates to systems and methods of authentication, and in particular to a method and system for authenticating to a remote server using a hardware security device.

2. Description of the Related Art

In many instances, a user needs to authenticate to a remote server/web site. For authentication purposes, the remote server or web site may use either a shared secret, private key, or digital signature verification algorithm. The shared secret/private key can be stored on a hardware-based security device such as a universal serial bus (USB) token or a smart card.

Unfortunately, the system that the user is using to gain access to the remote server (e.g. the client system, which may be a kiosk, for example) may not allow access to hardware security devices. This can be because the client system does not support the input/output (I/O) services required by the hardware security device (terminal) or the drivers and other software required to use the hardware security device is not available in the client server, and the user does not have sufficient privileges to install such software. What is needed is a way to allow a user to authenticate to a remote server using a client computer that does not support the I/O devices required by the hardware security device and which does not provide user privileges to install driver software.

Security tokens, including those that are compliant with the universal serial bus (USB), can be coupled to and used with host computers. However, such tokens typically require token-specific drivers that must be pre-installed on the host computer. Such drivers can be distributed in a variety of ways (floppy, CD-ROM, downloading from the Internet), even storing the driver itself on the token itself (as described in another proprietary patent disclosure). However, in some operating systems (e.g. Windows 2000 or XP) driver installation requires administrative-level privileges, and most users (particularly in situations where several users may be using a single computer) cannot be granted administrative-level privileges. What is needed is a way to allow use of a USB security token without requiring the user to install a vendor-specific device driver. The present invention satisfies this need.

### SUMMARY OF THE INVENTION

To address the requirements described above, the present invention discloses a method and apparatus for authenticating a user to a remote computer via a client computer. In one embodiment the invention is evidenced by a method comprising the steps of transmitting an authentication request from the client computer to the remote computer, generating a challenge from the authentication request, transmitting the challenge from the remote computer to the client computer, providing the challenge to an input/output (I/O) device communicatively coupled to a hardware security device (HSD), transmitting the challenge from the I/O device to the HSD, generating a response to the challenge using the challenge and data selected from the group comprising a shared secret and a private key, wherein the response is generated in the HSD, providing the response to the client computer, transmitting the response from the client computer to the remote computer, and granting authentication if the response compares favorably with an expected response computed by the remote computer from the challenge. In another embodiment, the invention is evidenced by an apparatus for supporting authentication of a user to a remote computer via a client computer. The apparatus comprises an input/output (I/O) interface compatible with a hardware security device (HSD), for transmitting a challenge to the HSD and for receiving a response to the challenge from the HSD, an I/O device, comprising a data presentation device communicatively coupled to the I/O interface, for presenting the response from the HSD, and a data input device communicatively coupled to the I/O interface, for accepting the challenge.

### BRIEF DESCRIPTION OF THE DRAWINGS

Referring now to the drawings in which like reference numbers represent corresponding parts throughout:

FIG. 1 is a diagram depicting a hardware environment for the present invention;

FIG. 2 is a chart presenting an illustrative example of operations that can be used to practice the present invention; and

FIG. 3 is a chart presenting an illustrative example of operations that can be used to practice another embodiment of the invention.

### DETAILED DESCRIPTION OF PREFERRED EMBODIMENTS

In the following description, reference is made by way of illustration, to several embodiments of the present invention. It is understood that other embodiments may be utilized and structural changes may be made without departing from the scope of the present invention.

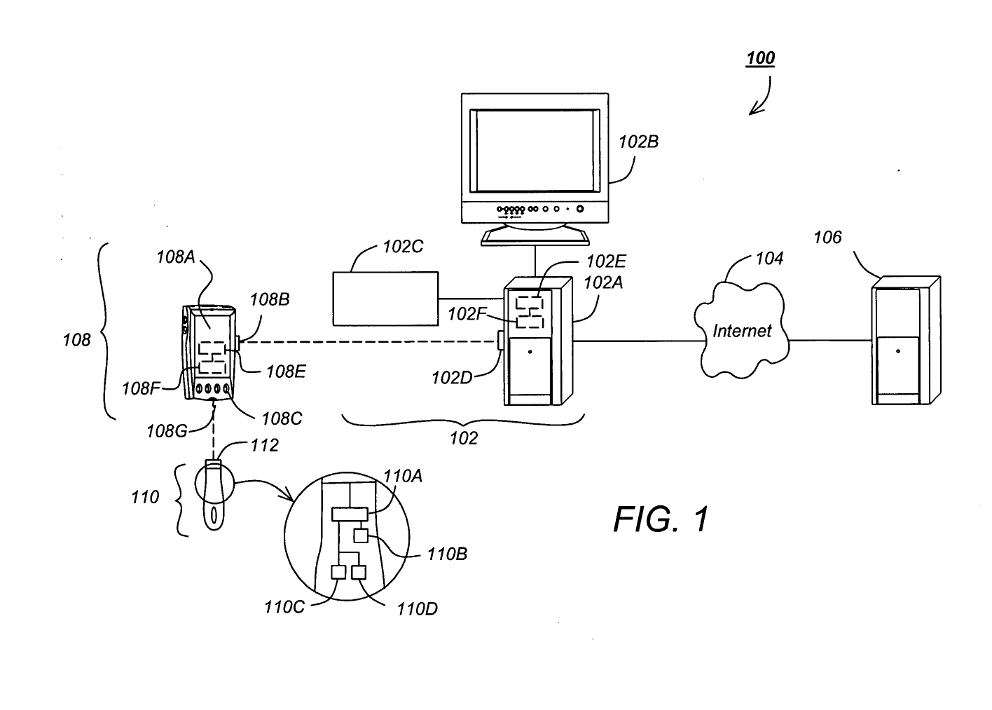

FIG. 1 is a diagram depicting a hardware environment for the present invention. The hardware environment 100 comprises a client computer system 102 communicatively coupled to a remote computer system 106 via a communication medium 104 such as the Internet, a local area network (LAN), wide area network (WAN), the public switched telephone network (PSTN) or wireless communication medium. The client computer system 102 can be presented to users as a shared or multi-user computer (such as that which might be used in a kiosk). The client computer system 102 typically comprises a client computer 102A coupled to a client computer display 102B and a client computer keyboard 102C. The client computer 102A includes a client computer processor 102E communicatively coupled to a client computer memory 102F. The client computer memory 102F stores instructions that are executed by the client computer processor 102E to perform the client computer 102 related functions.

The hardware environment 100 also comprises a portable I/O device 108. The portable I/O device includes a presentation device 108A for presenting information to a user, and one or more input device(s) 108C for accepting input from the user. In one embodiment, the portable device comprises a personal data assistant (PDA). PDAs, which can be integrated with a cellular telephone (e.g smart phones), typically include a touch sensitive display for presenting information and data to the user, and for accepting user input via the application of pressure on the display. Hence, the presentation device 108A may itself include a data input device providing input functionality in a single structural entity. User input can also be provided via other data input devices such as the illustrated buttons or an external or internal PDA keyboard.

The portable I/O device 108 includes a hardware security device (HSD) interface 108G that provides for data communication between the portable I/O device 108 and an HSD 110. The HSD interface 108G may be serial or parallel, and may be wired or wireless; and may include, for example, a USB-compliant interface, radio frequency (RF) interface (e.g. compliant with Bluetooth or 802.11), or infrared (IR) interface (transceiver), each conforming to well known data and physical interface standards and protocols.

Optionally, the portable I/O device 108 also includes a client computer interface 108B that communicates data with a client computer I/O port 102D. Like the HSD interface 108G, this interface may also be wired or wireless, and conforms to well-known data and physical standards and protocols.

Typically, the portable I/O device 108 includes a portable I/O device processor 108E and a communicatively coupled I/O device memory 108F storing processor 108E instructions and data for performing the operations of the portable I/O device 108.

The portable I/O device 108 can be communicatively coupled to a hardware security device (HSD) 110 such as a smartcard or a USB-compliant hardware key via interface 112, thus permitting communications therebetween. Optionally, the portable I/O device 108 can be communicatively coupled directly to the computer via I/O port 102D.

The HSD 110 includes a HSD processor 110A and a communicatively coupled HSD memory 110B, storing HSD processor instructions and other data. Typically, a portion of the memory 110B is logically and/or physically secure so that access to the data stored therein is limited to authorized users/requestors. Sensitive data, such as a shared secret (shared with the authenticating entity, which in FIG. 1, is the remote computer 106), or private key can be stored in the secure memory and optionally protected by a user personal identification number (PIN) that must be entered before access to the secure memory is permitted. Entry of the PIN can be accomplished with the use of the portable I/O device 108 or with the use of one or more integrated HSD input device(s) 110C and HSD output device(s) 110D. Examples of such integrated HSD devices can be found in co-pending and commonly assigned U.S. Patent Application “USB-COMPLIANT PERSONAL KEY WITH INTEGRAL INPUT AND OUTPUT DEVICES,” by Shawn D. Abbot et al., filed Nov. 24, 1999, which application is hereby incorporated by reference herein. Other examples of HSD devices can be found in U.S. patent application Ser. No. 09/281,017, filed Mar. 30, 1999 by Shawn D. Abbott, Bahram Afghani, Allan D. Anderson, Patrick N. Godding, Maarten G. Punt, and Mehdi Sotoodeh, and entitled “USB-Compliant Personal Key,” and now issued as U.S. Pat. No. 6,671,808.

As described above, one of the difficulties in the use of an HSD 110 is that their use typically requires that special purpose drivers be installed on the client computer 102A. Since this usually requires administrator-level privileges which would not be granted to users in most contexts (particularly a kiosk application), this problem cannot be solved by simply downloading and installing the appropriate drivers in the client computer.

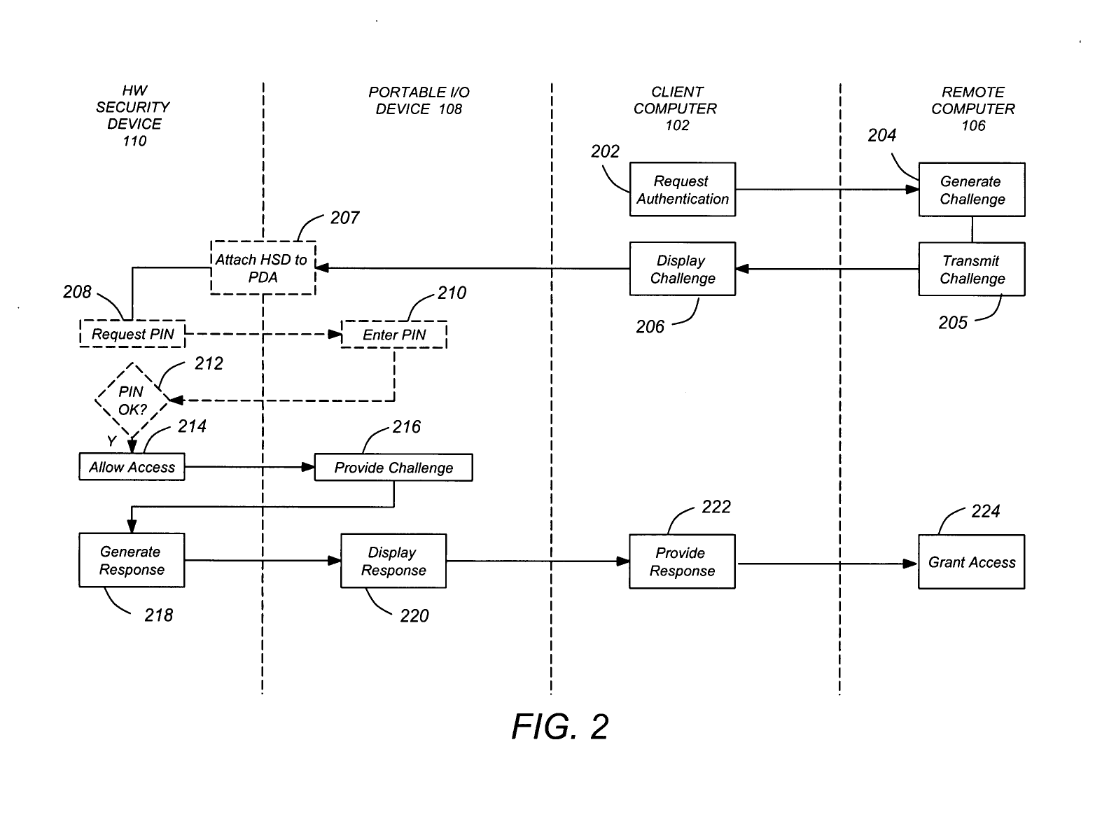

FIG. 2 is a diagram depicting one embodiment of the present invention in which the portable I/O device 108 is used to prompt the user to enter data required for authorization to proceed, and to accept that data and provide it to the client computer 102A.

The user begins by providing an input to the client computer 102A to request authentication by the remote computer 106. In block 202, a message requesting authentication is generated, and transmitted to the remote computer 106. The remote computer 106 generates 204 a challenge and transmits 205 the challenge to the client computer 102A. The client computer 102A then displays 206 the challenge to the user, using the display 102B or other device.

Of course, if the client computer 102A itself was the authentication entity, the operations shown in blocks 204 and 205 would occur in the client computer 102A itself.

If the user has not already done so, an HSD 110 is communicatively coupled to the portable I/O device 108 (hereinafter referred to as the PDA 108). This can be accomplished via a physical coupling (e.g. by plugging the HSD 110 into the HSD interface 108G) or by placing an HSD with a wireless transceiver (e.g. RF or IR) within the range of the HSD interface 108G of the portable I/O device 108.

If the HSD 110 requires entry of identifying information (e.g. access to the shared secret or private key is protected by a PIN, passphrase, or biometric authentication) the HSD 110 transmits a message to the portable I/O device 108 requesting that the user enter the identifying information (hereinafter referred to as the PIN), as shown in block 208. Alternatively, if the HSD 110 includes an integrated output device 110D, the request can be displayed on the HSD 110 itself.

The user enters 210 the PIN. If the PIN is entered into the portable I/O device 108, the PIN is then transmitted to the HSD 110. If the HSD 110 includes an integral input device 110C, the PIN can be entered directly into the HSD 110.

The HSD 110 compares the PIN to a securely stored PIN to determine if the correct pin was entered, as shown in block 212. If the incorrect PIN was entered, access to the HSD 110 is not permitted. If the correct PIN was entered, the user is successfully verified and user access is allowed, as shown in block 214.

The challenge is provided 216 to the portable I/O device 108. In one embodiment, the challenge is provided 216 to the portable I/O device 108 by displaying the challenge on either the client computer display 102B and/or the portable I/O presentation device 108A, and then accepting user entry of the challenge into the data input device (108B and/or 108C) of the portable I/O device. The drivers for displaying the challenge and accepting the user input can be resident in the HSD 110 or in the portable I/O device 108. The entered challenge is then transmitted from the portable I/O device 108 to the HSD 110.

Using the challenge and the data stored in the secure memory of the HSD 110 (e.g. the shared secret, or private key), the HSD 110 generates 218 a response from the challenge, and transmits a message to the portable I/O device 108 comprising the response. In one embodiment based on public/private key authentication, the HSD 110 response comprises a digital signature. In another embodiment based on shared secret authentication, the response comprises the hash value of a concatenation of the shared secret and the challenge, or a MAC value of the shared secret and the challenge.

The portable I/O device 108 displays 220 the response to the user. At this point, the user can enter 222 the response into the client computer 102A using the keyboard 102C or similar device, and the response is transmitted to the remote computer 106. The remote computer 106 evaluates the response by comparing it to the expected response. If the response received from the client computer 102A compares favorably with the expected response, authentication succeeds, as shown in block 224.

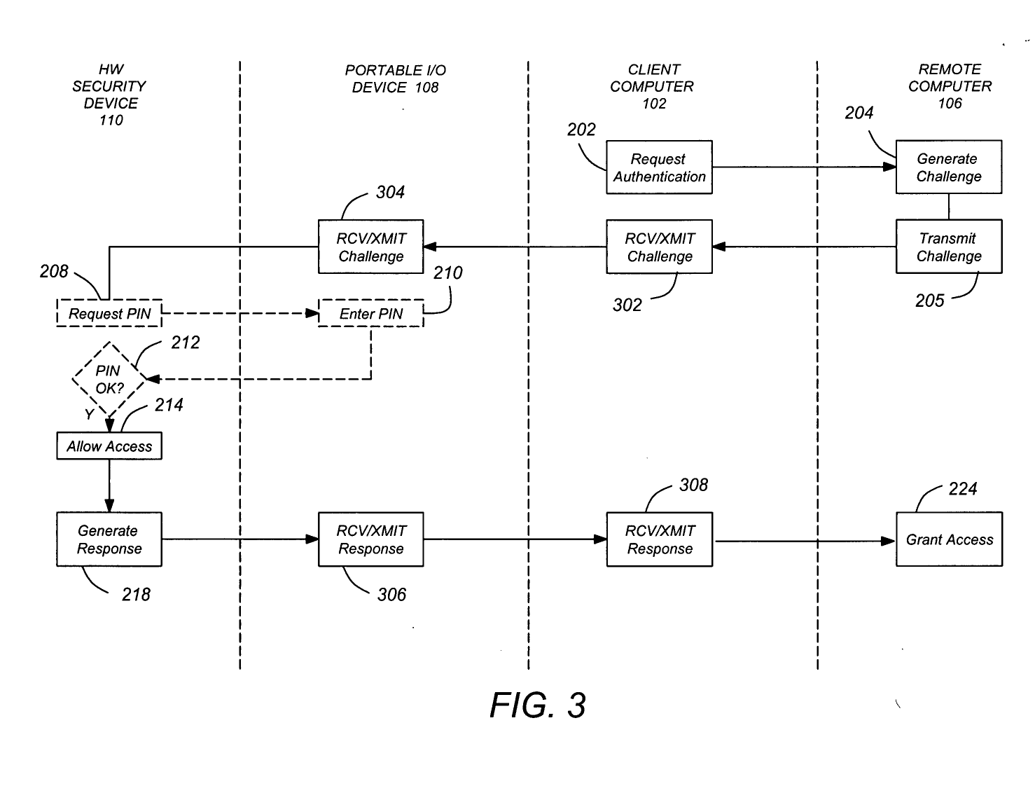

FIG. 3 is a diagram presenting another embodiment of the present invention. This embodiment does not require manual entry of challenges and responses. As was the case in the embodiment illustrated in FIG. 2, the client computer requests authentication by sending a message to the remote computer 106, as shown in blocks 202 and 204. The remote computer 106 receives the message and generates a challenge. The challenge is then transmitted from the remote computer 106 to the client computer 102A, where it is received, and transmitted to the personal I/O device 108, as shown in block 302. The interface is used to transmit the information from the client computer via client computer I/O port 102D. The information may be transferred via a wired or wireless interface. The portable I/O device 108 receives the challenge and transmits the challenge to the HSD 110. In one embodiment, the portable I/O device makes any modifications that are required to reformat or reprocess the challenge into a format that is suitable for transmission to the HSD 110. In another embodiment, the HSD is configured to accept and process the challenge without modification by the portable I/O device 108. Blocks 208-214 implement HSD 110 functionality that optionally requires entry of a user PIN before access to the HSD's secure memory is permitted.

In block 218, the HSD 110 generates a response, and transmits the response to the portable I/O device. The response is received, optionally reformatted, and transmitted by the portable I/O device 108 and the client computer 102A to the remote computer 106, as shown in blocks 306 and 308. Using the response, the remote computer 106 grants access, and transmits a message to the client computer 102A indicating that access has been granted.

### Conclusion

The foregoing description of the preferred embodiment of the invention has been presented for the purposes of illustration and description. It is not intended to be exhaustive or to limit the invention to the precise form disclosed. Many modifications and variations are possible in light of the above teaching. For example, the foregoing discussion discloses the use of a PDA for displaying information received from the HSD and for entering information to the HSD. However, the present invention can be practiced in embodiments wherein a simple I/O device is used instead of a PDA. If desired, some or all of the instructions required to support the display of information and the acceptance of data input can be resident in the HSD itself, allowing the I/O device to be produced at very low cost. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A method of authenticating a user to a remote computer via a client computer, comprising the steps of:
transmitting an authentication request from the client computer to the remote computer;
generating a challenge from the authentication request;
transmitting the challenge from the remote computer to the client computer;
providing the challenge to an input/output (I/O) device communicatively coupled to a hardware security device (HSD);
transmitting the challenge from the I/O device to the HSD;
generating a response to the challenge using the challenge and data selected from the group comprising a shared secret and a private key, wherein the response is generated in the HSD;
providing the response to the client computer;
transmitting the response from the client computer to the remote computer; and
granting access if the response compares favorably with an expected response computed by the remote computer from the challenge.

2. The method of claim 1, wherein the I/O device comprises a personal data assistant (PDA).

3. The method of claim 1, wherein the challenge is provided from the client computer to the I/O device and the response is provided from the I/O device to the client computer via an interface selected from the group comprising serial interface, a parallel interface, an IR interface, and an RF interface.

4. The method of claim 1, wherein:
the step of providing the challenge to the I/O device comprises the steps of:
displaying the challenge on a display communicatively coupled to the client computer; and
entering the challenge into the I/O device;
the step of providing the response to the client computer comprises the steps of
displaying the response on the I/O device;
accepting entry of the response in a keyboard communicatively coupled to the client computer.

5. The method of claim 1, further comprising the step of:
before generating the response to the challenge using the data, accepting a user-entered personal identification number (PIN) in the HSD, and verifying the user-entered PIN.

6. The method of claim 5, wherein the PIN is entered into the I/O device.

7. An apparatus for authenticating a user to a remote computer via a client computer, comprising:
means for transmitting an authentication request from the client computer to the remote computer;
means for generating a challenge from the authentication request;
means for transmitting the challenge from the remote computer to the client computer;
means for providing the challenge to an input/output (I/O) device communicatively coupled to a hardware security device (HSD);
means for transmitting the challenge from the I/O device to the HSD;
means for generating a response to the challenge using the challenge and data selected from the group comprising a shared secret and a private key, wherein the response is generated in the HSD;
means for providing the response to the client computer;
means for transmitting the response from the client computer to the remote computer; and
means for granting access if the response compares favorably with an expected response computed by the remote computer from the challenge.

8. The apparatus of claim 7, wherein the I/O device comprises a personal data assistant (PDA).

9. The apparatus of claim 7, wherein the challenge is provided from the client computer to the I/O device and the response is provided from the I/O device to the client computer via a PDA/client computer compatible serial, parallel, infrared (IR), or radio frequency (RF) interface.

10. The apparatus of claim 7, wherein:
the means for providing a challenge to the I/O device comprises:
means for displaying the challenge on a display communicatively coupled to the client computer; and
means for entering the challenge into the I/O device;
the means for providing the response to the client computer comprises the steps of
means for displaying the response on the I/O device;
means for accepting entry of the response in a keyboard communicatively coupled to the client computer.

11. The apparatus of claim 7, further comprising the steps of:
means for accepting a user-entered personal identification number (PIN) in the HSD, and means for verifying the user-entered PIN before generating the response to the challenge using the data.

12. The apparatus of claim 11, wherein the PIN is entered into the I/O device.

13. An apparatus for supporting authentication of a user to a remote computer via a client computer, comprising:
an input/output (I/O) interface compatible with a hardware security device (HSD), for transmitting a challenge to the HSD and for receiving a response to the challenge from the HSD;
an I/O device, comprising
a data presentation device communicatively coupled to the I/O interface, for presenting the response from the HSD; and
a data input device communicatively coupled to the I/O interface, for accepting the challenge.

14. The apparatus of claim 13, wherein the HSD comprises a processor implementing instructions for driving the data presentation device and the data input device.

15. The apparatus of claim 13, further comprising a processor, communicatively coupled to the I/O interface, the data presentation device, and the data input device, for implementing instructions for driving the data presentation device and the data input device.

16. The apparatus of claim 13, wherein the HSD is a USB-compliant token and the I/O interface is a USB-compliant interface.

17. The apparatus of claim 13, wherein the HSD is a smartcard and the I/O interface is a smart card compliant interface.

18. The apparatus of claim 13, wherein the I/O device is a personal data assistant (PDA).

19. The apparatus of claim 13, wherein the response is generated using the challenge and data selected from the group comprising a shared secret and a private key, wherein the response is generated in the HSD

20. An apparatus for providing input to and receiving output from a hardware security device (HSD), comprising:
an HSD-compliant I/O interface;
a data presentation device communicatively coupled to the HSD-compliant I/O interface, for presenting data received from the HSD; and
a data input device, communicatively coupled to the HSD-compliant I/O interface, for accepting data entry;
wherein the data presentation device and the data input device are driven by a driver of the HSD.

21. The apparatus of claim 20, wherein the HSD comprises an HSD processor and an HSD memory communicatively coupled to the processor, and the driver is implemented by the HSD processor performing instructions stored in the HSD memory.

22. The apparatus of claim 20, wherein the HSD-compliant I/O interface is selected from the group comprising:
a universal serial bus (USB) interface;
an infrared (IR) interface; and
a radio frequency (RF) interface;
a smart card interface.

23. A method of authenticating a user to a remote computer via a client computer, comprising the steps of:
transmitting an authentication request from the client computer to the remote computer;
receiving a challenge in the client computer, the challenge generated by the remote computer in response to the authentication request;
providing the challenge to a input/output (I/O) device communicatively coupled to a hardware security device (HSD);
transmitting the challenge from the I/O device to the HSD;
receiving a response to the challenge from the HSD, the response generated in the HSD;
transmitting the response from the client computer to the remote computer; and
receiving a message indicating successful authentication from the remote computer if the response compares favorably with an expected response generated by the remote computer from the challenge.

24. The method of claim 23, wherein the response is generated using data selected from the group comprising a shared secret and a private key.

25. The method of claim 23, wherein the I/O device comprises a personal data assistant (PDA).

26. The method of claim 23, wherein the challenge is provided from the client computer to the I/O device and the response is provided from the I/O device to the client computer via an interface selected from the group comprising a serial interface, a parallel interface, an infrared (IR) interface, and a radio frequency (RF) interface.

27. The method of claim 23, wherein:
the step of providing a challenge to the I/O device comprises the steps of:
displaying the challenge on a display communicatively coupled to the client computer; and
entering the challenge into the I/O device; the step of receiving the response to the challenge from the HSD comprises the steps of
displaying the response on the I/O device;
accepting entry of the response in a keyboard communicatively coupled to the client computer.

28. The method of claim 23, further comprising the step of
before transmitting the challenge from the I/O device to the HSD, accepting a user-entered personal identification number (PIN) in the HSD, and verifying the user-entered PIN.

29. A method of authenticating a user to a remote computer via a client computer, comprising the steps of:
receiving a challenge in a hardware security device (HSD), the challenge obtained from an input/output (I/O) device communicatively coupled to the client computer and computed in the remote computer in response to an authentication request from the client computer;
generating a response in the HSD using the challenge and data selected from the group comprising a shared secret and a private key; and
providing the response from the HSD to the client computer, the response permitting successful authentication upon transmittal to the remote computer if the response compares favorably with an expected response computed by the remote computer from the challenge.

30. The method of claim 29, wherein the I/O device comprises a personal data assistant (PDA).

31. The method of claim 29, wherein the challenge is received from the I/O device and the response is transmitted to the I/O device via a wireless interface.

32. The method of claim 29, wherein the wireless interface is selected from the group comprising a radio frequency (RF) interface and an infrared (IR) interface.

33. The method of claim 29, wherein the step of providing the response from the HSD to the client computer comprises the steps of:
transmitting the response from the HSD to the I/O device;
presenting the response on the I/O device;
entering the presented response in an input device communicatively coupled to the computer
